(19) United States
(12) Patent Application Publication
(10) Pub. No.: US 2015/0161665 A1
(43) Pub. Date: Jun. 11, 2015

(54) SYSTEM AND METHOD OF PREDICTING A LOCATION OF A CONSUMER WITHIN A RETAIL ESTABLISHMENT

(71) Applicant: Catalina Marketing Corporation, St. Petersburg, FL (US)

(72) Inventors: Michael GRIMES, Brookeline, MA (US); Tyler Richard NOLAN, Sayville, NY (US); Patricia Michelle DIVITA, Rockwall, TX (US); Ambika KRISHNAMACHAR, Darien, CT (US)

(73) Assignee: Catalina Marketing Corporation, St. Petersburg, FL (US)

(21) Appl. No.: 14/101,092

(22) Filed: Dec. 9, 2013

(51) Int. Cl. G06Q 30/02

(52) U.S. Cl. CPC G06Q 30/0261

(57) ABSTRACT

The disclosure relates to systems and methods of predicting one or more locations to which a consumer will travel within a retail establishment during a current shopping trip based on prior shopping histories, current in-store behavior, and demographic information. The system may make the predictions based on a model of a population of consumers to determine correlations between prior shopping histories and demographic information and locations visited during previous shopping trips. A particular consumer's shopping histories, current in-store behavior, and demographics may be used to identify an appropriate model for the consumer. The system may use the model to make the predictions and provide information such as incentives based on the predictions.

### FIELD OF THE INVENTION

The invention relates to systems and methods of predicting one or more locations to which a consumer will travel within a retail establishment based on prior shopping histories, current in-store behavior, and/or other information and providing information such as incentives based on the predictions.

### BACKGROUND OF THE INVENTION

Incentives such as advertisements, coupons, rebates, or other promotions are typically relevant to only a fraction of the audience that receives them. Marketers and others have long used various techniques to target particular groups or individuals in an attempt to deliver incentives that are relevant to their recipients. Other information such as recipes, nutritional information, apparel information such as sizing, and/or other information are similarly difficult to appropriately target to groups or individuals.

One approach for improving distribution of targeted incentives has included determining a user's current location, and identifying (for delivery) information that is relevant to the determined location. However, a user's current location may be insufficient to capture the user's interest because the current location may be transient. In other words, a user may have moved on to a different location (or store) before meaningful information can be identified and delivered.

Furthermore, different retailers may have different store layouts, carry different items for sale, and typically do not share their customer's data with one another. Even within the same retail chain, different stores can have different layouts and carry different items for sale. This can make targeting incentives for a customer difficult because a given location within one retail store may be associated with different items than another location of another retail store.

### SUMMARY OF THE INVENTION

The invention addressing these and other drawbacks relates to systems and methods of predicting one or more locations to which a consumer will likely travel within a retail establishment during a current shopping trip. The system may provide information that is relevant to the predictions such as an incentive for an item to which the consumer will likely travel, or will likely pass en route to a predicted location.

The system may take into account a consumer's current and/or previous locations during the current shopping trip to make predictions of likely next locations. For example, the system may include a computer that receives location information from a tracking device that the consumer may use while shopping in a retail establishment. The tracking device may comprise a mobile device (e.g., the consumer's mobile device) that is programmed with a self-scan mobile application, a scanner device provided by the retail establishment for use in a self-scan system, a location monitor that is used to determine a location, and/or other type of device that can provide location information. As such, the system may operate in a retail establishment that provides a self-scanning and/or location-aware system.

The computer may be programmed with computer program instructions to predict one or more next locations to which a consumer will likely travel within the retail establishment. For example, the computer may be programmed with a location application that includes one or more instructions such as a registration instructions, location modeling instructions, consumer profile instructions, current trip instructions, location predictor instructions, normalization instructions, and/or other instructions.

The registration instructions may program the computer to process registration information from a retailer, a consumer, and/or other user. For example, a retailer may provide retail-specific information, including purchase transaction information of its customers and planogram information that is used to locate items in a retail establishment of the retailer. A consumer may provide consumer identifiers (e.g. loyalty program identifiers), mobile device or application identifiers, demographic information, and/or other information.

The location modeling instructions may program the computer to model a population of consumers and their visited locations within a retail establishment to predict locations to which a similarly situated consumer may travel. The computer may be programmed to obtain information that indicates previous locations that were visited by individual members of a population and one or more variables (e.g., prior shopping histories, demographics, etc.) that describe the population.

The computer may be programmed to model the population of consumers by correlating the locations visited by the consumers with the one or more variables. For example, a given variable such as basket size may be correlated with a particular item (and therefore location) that was scanned. The foregoing correlation and/or other correlations may be used to infer that consumers tending to have similar basket sizes or other variables will visit similar locations during their shopping trip. In some implementations, the computer may be programmed to determine a level of consistency of one or more such variables observed in the shopping behavior of individual members of a population of consumers. For example, a consistency in basket size observed for given consumers (e.g., the consumers tend to have the same or similar basket sizes across a number of shopping trips) may be used to group those consumers for later comparisons and/or correlate the consistency in basket size to one or more visited locations.

In some implementations, the location modeling instructions may program the computer to segment the population of consumers into groups that share similar characteristics. By grouping the population of consumers, the computer may generate models for each group to increase accuracy of the models because similarity among group members may suggest tighter correlations between their characteristics and visited locations.

In some implementations, the consumer profile instructions may program the computer to classify a given consumer. The classification may be based on prior shopping behaviors, demographic information, and/or other information known about the consumer. The classification of the consumer may be used to compare the consumer against the population of consumers and/or the groups of consumers that were modeled in order to identify an appropriate model to predict locations to which the consumer will likely travel during a given shopping trip.

In some implementations, the current trip instructions may program the computer to obtain current trip information that describes a current shopping trip. For example, the current trip instructions may program the computer to process an identifier that is associated with the characteristics and/or classification of the consumer. The current trip instructions may program the computer to process current locations of the consumer (e.g., by processing items scanned during the shopping trip using a self-scanning device), time between locations (e.g., time between scans), and/or other information related to the current shopping trip.

In some implementations, the location predictor instructions may program the computer to process the information related to the population of consumers, groups of consumers, consumer classification, and the current trip information to identify an appropriate model for the consumer, and to predict locations to which the consumer will likely travel during a current shopping trip. For example, the computer may be programmed to determine a set of locations (which includes a current location of the consumer as determined from the current trip information) where the modeled population, group of consumers, and/or the consumer has traveled during previous shopping trips. Based on the set of locations, location predictor instructions may predict a location to which the consumer will travel during a current shopping trip.

In some implementations, the location predictor instructions may program the computer to predict different locations for different intervals of time. For example, the consumer may be predicted to travel to a first location within a minute and be predicted to travel to a second location within five minutes. These different predictions may be made together (e.g., all at one time) or serially (one or more after another in series).

In some implementations, the location predictor instructions may program the computer to use different models based on current shopping behavior of the consumer. For example, if the consumer scans an item or otherwise traverses to a location that is not anticipated by the currently used model, the computer may be programmed to select a new model based on the updated information. In this manner, the system may calibrate itself in real-time during a current shopping trip to reflect updated information.

In some implementations, the normalization instructions may program the computer to normalize location and/or item information across different retail establishments. For example, the computer may be programmed to categorize a particular item and associate a category of the item with a location. In this manner, if a given retailer does not sell the particular item, a location of a class of items to which the particular item belongs may be known by the system. For example, if a given retail establishment does not sell a particular item such as sugar cookies, the normalization instructions may program the computer to determine a class to which sugar cookies belongs (e.g., baked goods) and determine that sugar cookies would be located in the baked goods section of the given store. Other normalizations that allow the system to provide predicted locations across different retail establishments may be used as well.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for predicting one or more next locations of a consumer within a retail establishment, according to an implementation of the invention.

FIG. 2 illustrates a flow diagram of a system of predicting one or more next locations of a consumer within a retail establishment, according to an implementation of the invention.

FIG. 3A schematically illustrates a first direction of travel within a retail establishment, according to an implementation of the invention.

FIG. 3B schematically illustrates a second direction of travel within a retail establishment, according to an implementation of the invention.

FIG. 4 schematically illustrates predictions of one or more next locations made at various intervals along a timeline, according to an implementation of the invention.

FIG. 5 illustrates a process of generating a model of locations visited and one or more variables related to a population of consumers that have previously shopped within a retail establishment, according to an implementation of the invention.

FIG. 6 illustrates a process of predicting one or more next locations of a consumer within a retail establishment, according to an implementation of the invention.

FIG. 7 illustrates a process of determining a model used to predict predicting one or more next locations of a consumer within a retail establishment, according to an implementation of the invention.

### DETAILED DESCRIPTION OF THE INVENTION

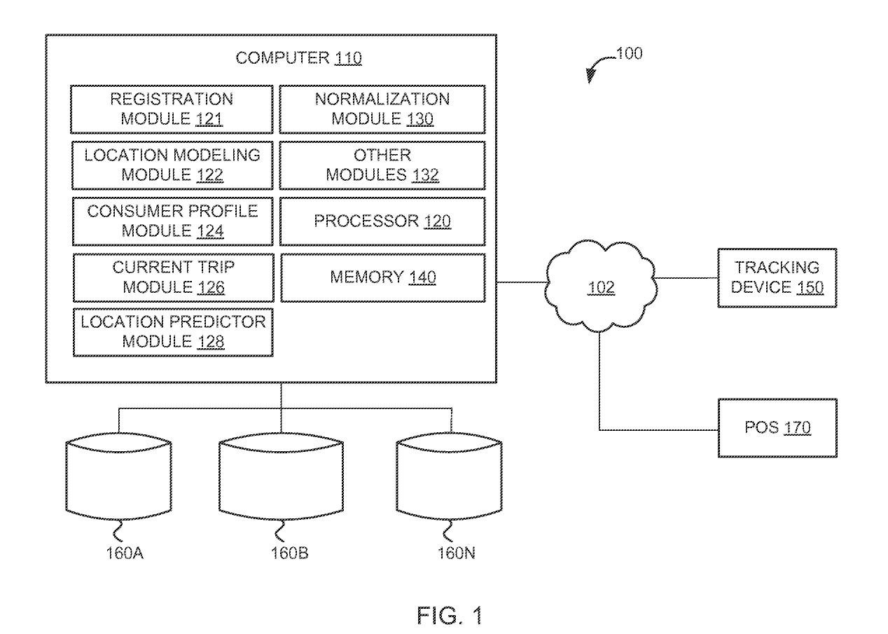

FIG. 1 illustrates a system 100 for predicting one or more next locations to which a consumer will travel within a retail establishment, according to an implementation of the invention. The one or more next locations may include an aisle, an item location, a location of a category of items, a department, and/or other location to which a consumer will likely travel within the retail establishment during a shopping trip. The retail establishment may include, for example, a grocery store, a shopping mall, an outdoor pavilion, and/or other retail establishment within which a consumer may traverse. All or portion of the retail establishment may be indoors, outdoors, or a combination of indoors and outdoors. The shopping trip may include a starting time of the shopping trip (e.g., when a self-scan device and/or application is initialized to scan items in a self-scan system, or when the consumer enters the retail establishment, etc.), locations visited after the starting time, and an ending time of the shopping trip (e.g., when checkout of items scanned occurs, or when the consumer leaves the retail establishment, etc.).

System 100 may obtain an identification of a consumer and a retail establishment at which the consumer is shopping during a current shopping trip, a current location of the consumer within the retail establishment, and predict one or more next locations that the consumer may visit based on the current and/or prior location of the consumer within the retail establishment. For example, system 100 may use the consumer's prior and/or current location as a parameter, among other information, to determine the one or more next locations. The prior and current locations of the consumer may each be determined based on a scan of an item in a self-scan system (e.g., system 100 assumes that the consumer is (or was) located at or nearby the location of a scanned item), one or more signal processing localization techniques (e.g., triangulation, trilateration, received signal strength indications, etc.) used to locate a device that is carried by (or located nearby) the consumer, and/or other techniques that may be used to locate the consumer within the retail establishment.

In some implementations, system 100 may predict a path from the current location to the one or more next locations. A path may include a prior location (which may include an initial location determined based on a first scanned item or when the consumer was otherwise first located in the retail establishment), a current location, the one or more next locations, and/or other locations.

System 100 may predict the one or more next locations and/or the one or more paths based on a model that predicts one or more locations that the consumer and/or other consumers will travel to while at the retail establishment. For example, system 100 may generate a plurality of models corresponding to different segments of consumers and select a particular model that is appropriate for a given consumer. Each of the models may be generated based on one or more of consumer characteristics, information specific to a retail establishment, and/or other information that can provide clues as to where the consumer will travel within the retail establishment.

System 100 may identify and provide an incentive based on the one or more next locations, the path from the current location to the one or more next locations, the current location, and/or other location information. For example, the system may provide an incentive related to one or more items that are at (or nearby): the current location, the next location, a location associated with the path, and/or another location.

Other uses of system 100 are described herein and still others will be apparent to those having skill in the art. Having described a high level overview of some of the system functions, attention will now be turned to various system components that facilitate these and other functions.

System 100 may include a computer 110, a tracking device 150, one or more databases 160 (illustrated in FIG. 1 as databases 160A, 160B, . . . , 160N), a point of sale (“POS”) device 170, and/or other components. Tracking device 150 may obtain information that is used to determine a current location of a consumer in a given retail establishment. For example, tracking device 150 may include a self-scanning device (e.g., a consumer's mobile device programmed with a self-scan mobile application that scans items whose locations are known, a self-scan device provided by a retailer, a location device that provides other types of location information, etc.). The scanning device may communicate with POS 170 for checking out or otherwise paying for a purchase transaction.

Computer 110 may obtain self-scans, and/or other location information to determine a current location (as well as track previous locations) of the consumer during a current shopping trip, and predict one or more next locations to which the consumer will likely travel.

Computer 110 may include one or more processors 120 programmed by one or more computer program instructions. For example, processors 120 may be programmed by a location application 180, which may include registration instructions 121, location modeling instructions 122, consumer profile instructions 124, current trip instructions 126, location predictor instructions 128, normalization instructions 130, and/or other instructions 132.

In some implementations, registration instructions 121 may program processors 120 to register various users such as retailers and consumers to use the system.

Location modeling instructions 122 may program processors 120 to model a population of consumers to correlate locations that individual members of the population have visited during observed shopping trips with characteristics of those consumers. One or more members of the population may be segmented into groups of consumers that are similar to one another.

Consumer profile instructions 124 may program processors 120 to classify a given consumer using the same or similar variables that are used to segment groups of consumers. In this manner, a given consumer may be classified to determine to which group of consumers that the given consumer is most similar.

Current trip instructions 126 may obtain current trip information that describes a current shopping trip of the given consumer.

Location predictor instructions 128 may program processors 120 to predict one or more next locations of the given consumer by comparing the classification of the given consumer with one or more groups of consumers and selecting a model that is appropriate for the given consumer.

Normalization instructions 130 may program processor 122 to normalize location information across different retail establishments so that predictions may be applicable irrespective of where a current shopping trip is taking place.

In some implementations, registration instructions 121 may program processor 122 to obtain registration information from users such as retailers, consumers, and/or other users. For example, registration instructions 121 may obtain inventory information, planograms, store hours, department hours, and/or other retail-specific information for the retailers. In some implementations, registration instructions 121 may obtain retailer preferences such as various threshold settings described herein. Retailer information obtained from the registration process may be stored in one or more databases described herein. Registration instructions 121 may obtain demographic information, preference information, loyalty membership information, and/or other information from consumers. The user registration information may be stored in one or more databases described herein.

Correlating Previous Consumer Behavior and Consumer Information with Locations Visited

In some implementations, location modeling instructions 122 may program processor 122 to generate one or more models used to predict a location to which a given consumer will likely travel in a retail establishment during a shopping trip. Location modeling instructions 122 may obtain: (i) locations that were visited by a population of one or more consumers during previous shopping trips at retail establishments, and (ii) one or more variables that describe the one or more consumers and/or the retail establishments. The one or more variables may be correlated with the previously visited locations to discover patterns. By identifying such patterns, locations of consumers who share similar values for the variables may be predicted during a given shopping trip based on the previously visited locations.

Location modeling instructions 122 may use various types of regression analysis, machine learning, and/or other analytical framework to correlate the variables (e.g., the value of the variables or the variables themselves) with the previously visited locations. Such correlations may be used to predict a next location to which a consumer may travel during a current (e.g., in-progress) shopping trip, as described below with respect to location predictor instructions 128. For example, location modeling instructions 122 may use machine learning to identify variables, combinations of variables, relative importance of variables (e.g., level of correlation between a given variable and a visited location as a measure of relative importance), and/or threshold values for those variables that are correlated with visited locations. In this manner, location modeling instructions 122 may automatically refine models used to predict locations based on an analysis of new and existing information related to the variables and visited locations.

The one or more variables may relate to previous shopping behavior of individual members of the population of consumers, demographic information that describes the individual members, retailer-specific information that describes a retail establishment at which the individual members previously shopped, and/or other information.

Variables that relate to previous shopping behavior may include, for example, a direction of travel, a basket size (also referred to herein as “basket information”), locations visited, a time between locations or scans, shopper-specific buying patterns such as combinations of items purchased, store-specific buying patterns such as combinations of items purchased in a given retail establishment, and/or other information.

The direction of travel may indicate a general direction taken by a member of the population during previous shopping trips. For example, a given member of the population may begin a shopping trip from the dairy section, travel to the meat section and end the shopping trip at the frozen food section. Such directionality of travel may, in some implementations, be abstracted to be classified as “clockwise” or “counter-clockwise,” depending on the direction of travel along which the sequence of locations were visited. In some of these implementations, if a given member of the population backtracks or moves in a manner that is not completely clockwise or counter-clockwise, location modeling instructions 122 may determine the direction in which the given member most often traveled during a given previous shopping trip and characterize the previous shopping trip based on the determined direction.

For example, if a given member of the population mostly traveled in a clockwise direction during a previous shopping trip, location modeling instructions 122 may characterize the previous shopping trip as having been travelled in a clockwise direction. Directions travelled during a shopping trip (whether characterized as having a single direction—“clockwise” or “counter-clockwise”—or multiple directions), may be correlated to locations visited. In other words, members of the given population that travelled in a clockwise direction may tend to visit a first set of locations (and in particular order) while members of the given population that travelled in counter-clockwise or different direction may tend to visit a second set of locations (and in a different order).

The basket information may include information that describes items placed in a cart during a previous shopping trip, such as a number of items, an average price per item, a total price of all items, and/or other information that relates to items placed in the cart.

The locations visited may include information that indicates an initial location where a previous shopping trip began (e.g., a first item that was scanned), subsequent locations visited during the shopping trip, a final location (e.g., a last item that was scanned), and/or other information that relates to locations that were visited during a previous shopping trip.

The time between locations may include information that describes a duration of time between two or more individual locations that were visited during a previous shopping trip. For example, the time between locations may include a time between when an individual member of the population scanned a first item and a second item.

The shopper-specific buying patterns may include information that indicates combinations of items purchased, items purchased during different times of the year (e.g., beginning of the week, end of the month, etc.), and/or other information that indicates shopping patterns for a given member of the population.

The store-specific buying patterns may include information that indicates combinations of items purchased in a given retail establishment, items purchased during different times of the year (e.g., beginning of the week, end of the month, etc.), and/or other information that indicates shopping patterns for a given member of the population.

Variables that relate to demographic information may include age, gender, family size, ages of family members, ethnicity, geographic location (e.g., residence address, work address, income, marital status, etc.), and/or other demographic information.

Variables that relate to retailer-specific information may include a proximity of products to one another (e.g., based on planogram information of a particular retail establishment), inventory information (e.g., an availability of a product in a given retail establishment, etc.), store/department hours, and/or other retailer-specific information. For example, distances between different products may be correlated with whether and how often members of the population travel to locations where the different products are shelved. Different store hours may be correlated with different shopping behaviors and therefore locations visited by the members of the population.

Location modeling instructions 122 may correlate one or more of the foregoing variables with locations visited by members of the population. In this manner, consumers who exhibit similar behavior and/or have similar demographics may be predicted to also travel to the locations visited by the members of the population. In implementations where multiple variables are used for the correlation between variables and locations visited, location modeling instructions 122 may assign a weight to individual variables that define a relative importance of each. In some implementations, the variables used (including a single variable in some implementations) and any weights assigned to them may be automatically determined by location modeling instructions 122, may be predefined, and/or may be configured by a user (e.g., during the registration process described above, an update to the registration information, etc.).

In some implementations, location modeling instructions 122 may generate a given model that is specific to a particular retail establishment, specific to different chains or types of retail establishments (e.g., a particular retail grocery chain or all grocers), or generally applicable to different types of retail establishments. As such, a given model may be used to predict a consumer's location within a single retail establishment, a chain of retail establishments, a type of retail establishment, all retail establishments, or other retail establishments. In some implementations, location modeling instructions 122 may generate a given model that is specific to a particular consumer, a particular group of consumers (e.g., consumers who share in common a particular geographic area or other characteristic) and/or other individualized sets of consumers.

In some implementations, location modeling instructions 122 may generate a given model that is specific to particular values of the variables described herein. For example, a model may be generated for small basket sizes (e.g., 1-10 items or other numeric range of items), medium basket sizes (e.g., 11-20 items or other numeric range), large basket sizes (e.g., greater than 20 items), and/or other types of baskets. Other values for other variables may be similarly used as well. In these implementations, different models may apply to different types of shopping trips. Location modeling instructions 122 may correlate that a given consumer may visit certain locations during a short shopping trip (e.g., small basket size) but may visit other locations for a different length shopping trip (e.g., large basket size).

In some implementations, location modeling instructions 122 may modify a model or otherwise generate a model to take into account promotional/sale activity. For example, double coupon days or other promotions may alter consumer behavior such that locations they visit during such promotional activity changes from what may otherwise be a routine pattern of locations visited. Location modeling instructions 122 may model such altered behavior based on observations of locations visited by members of the population during similar promotions.

In some implementations, location modeling instructions 122 may determine how consistently a given consumer in the population shops. For example, location modeling instructions 122 may determine whether a given consumer in the population, across a number of previous shopping trips, consistently has the same or similar basket size, consistently travels in the same or similar direction, consistently travels to the same or similar locations, and/or consistently exhibits other shopping behaviors. Whether a given behavior is “consistent” across a number of shopping trips may be predefined and/or configurable by a user of the system. For example, location modeling instructions 122 may determine that a basket size is consistent for a given consumer over a number of shopping trips when the standard deviation for basket size (and/or other variable described herein) is within a threshold value.

Location modeling instructions 122 may correlate such consistency with locations visited by the member of the population. For example, consumers who tend to have consistent shopping behaviors may tend to consistently visit the same locations, leading to more tight correlations between shopping behaviors and locations visited during previous shopping trips.

Grouping Consumers into Segments

In some implementations, location modeling instructions 122 may group the population of consumers into one or more segments. Each segment may include one or more members of the population of observed consumers that share in common at least one characteristic with one another. Location modeling instructions 122 may group consumers into a given segment based on values of one or more of the foregoing variables that are associated with each consumer and/or based on the level of consistency in shopping behavior that each consumer exhibited. For example, consumers in a given segment may each be associated with the same or similar basket sizes, the same or similar locations visited during previous shopping trips, the same or similar level of consistency and/or the same or similar value for other variables described herein.

Location modeling instructions 122 may group two or more consumers into a given segment based on a threshold value, which may be predefined and/or configured by a user of the system. For example, location modeling instructions 122 may group two consumers into a segment if their respective average basket sizes from previous shopping trips are within two items of one another. Any of the variables described herein or combinations of the variables may be used to segment consumers. In some of these implementations, a weight may be applied to each variable to determine a relative importance of each variable when grouping consumers into segments.

Location modeling instructions 122 may group two or more consumers into a given segment based on consistency in shopping behaviors. For example, location modeling instructions 122 may group two consumers that exhibit similar levels of consistency in their shopping behaviors into a segment. Such levels of similarity in consistency required to group the consumers may be predefined and/or configurable.

By grouping consumers into segments, location modeling instructions 122 may make correlations within a given segment, leading to stronger correlations and more accurate predictions within the given segment because consumers that are similar to one another may tend to visit the same locations during respective shopping trips.

Having described the analytical framework and modeling performed by the system used to predict next locations, attention will now be turned to application of the model to predicting a particular consumer's next locations during a current shopping trip.

Analyzing and Predicting Locations During a Current Trip

During a current shopping trip of a given consumer, system 100 may predict one or more next locations to which the given consumer may travel based on a comparison of the characteristics of the given consumer with the correlations described herein. The characteristics of the given consumer may be described in a consumer profile.

In some implementations, consumer profile instructions 124 may program processor 122 to obtain information about a particular consumer to generate the consumer profile. In this manner, a given consumer may be classified so that the system may compare the given consumer to a group of one or more consumers (e.g., members of the population whose previous shopping behavior and demographics were used to build the models/correlations described above with respect to location modeler instructions 122) that are most similar to the given consumer.

For example, consumer profile instructions 124 may obtain information related to previous purchases made by the consumer, items scanned, time between scans, consistency in prior behaviors, demographic information, and/or other information. Generally speaking, consumer profile instructions 124 may classify a given consumer using the one or more variables used to make correlations for the population of consumers as described with respect to location modeler instructions 122.

In some implementations, the given consumer may be classified into more than one such classification. For example, the given consumer may tend to make different types of shopping trips depending on the day of the week, number of items to be purchased, and/or other factors. In this manner, the system may predict locations that will be visited by the consumer based on the type of shopping trip, for example, in which the consumer is engaged during a current shopping trip.

In some implementations, consumer profile instructions 124 may generate the consumer profile on-demand during a current shopping trip and/or prior to a current shopping trip and stored in one or more databases described herein for later retrieval during the current shopping trip.

In some implementations, current trip instructions 126 may program processor 122 to obtain information that is used to identify a consumer that is involved in a current shopping trip. The information may also be used to identify values for the one or more variables described herein (e.g., locations visited, items scanned, etc.), and/or other information related to the current shopping trip.

In some implementations, current trip instructions 126 may obtain an identifier that is used to identify the consumer involved in the current shopping trip. The identifier may identify a tracking device 150 used by the consumer during the current shopping trip, an account of the consumer (e.g., a loyalty account, payment account, etc.), a consumer identifier, and/or other information that can be used to identify the consumer. Whichever type of identifier is obtained, current trip instructions 126 may identify the consumer based on a pre-stored association of the identifier with the consumer.

For example, during the current shopping trip, the consumer may use a tracking device 150. The tracking device 150 may include a mobile device of the consumer (e.g., a mobile device that is carried into the retail establishment by the consumer), a self-scanning device provided by the retail establishment, and/or other device that can be used to determine the location of the consumer in the retail establishment.

The mobile device of the consumer may be programmed by a self-scan mobile application to scan items as the user traverses the retail establishment. Current trip instructions 126 may obtain the identifier from the self-scan mobile application and identify the consumer based on the identifier. For instance, the identifier may be read from a medium (such as a loyalty card) that encodes the identifier. In another example, the self-scan device provided by the retail establishment may read the identifier from a medium that encodes the identifier (e.g., a loyalty card) or otherwise receive the identifier as input from the consumer, which is provided to current trip instructions 126.

In some implementations, current trip instructions 126 may obtain an identity of the retail establishment at which the current shopping trip is occurring. For instance, current trip instructions 126 may receive the identification of the retail establishment from the tracking device 150. In this manner, current trip instructions 126 may obtain the identity of the consumer and the identity of the retail establishment at which the current shopping trip is taking place.

In some implementations, current trip instructions 126 may obtain locations within the retail establishment at which the consumer has visited (or is visiting) during the current shopping trip. For example, in implementations where the tracking device 150 includes a self-scan feature (e.g., the mobile device of the consumer or the self-scan device provided by the retail establishment), the locations may be determined based on a scan of an item using the self-scan feature. When a consumer scans an item, for instance, current trip instructions 126 may determine a location of the scanned item, obtain a time of the scan, and determine that the consumer was at the location of the scanned item at the time of the scan.

The location of the scanned item may be determined based on planogram or other information that includes an association of an item and a location of the item in the retail establishment. Such planogram or other information may be stored in one or more databases described herein. In some implementations, current trip instructions 126 associates the first scanned item with a first visited location during the current shopping trip and the last scanned item with a last visited location during the current shopping trip.

In some implementations, the tracking device 150 includes location tracking capabilities such as by using triangulation, trilateration, received signal strength indication, and/or other location techniques. In these implementations, current trip instructions 126 may periodically obtain a location of the tracking device 150 at various times.

In some implementations, current trip instructions 126 may classify the current shopping trip so that appropriate models/correlations may be used to predict next locations to which the given consumer will likely travel. For example, a given consumer may tend to make different types of shopping trips, such as quick trips (e.g., a “small basket”) to longer trips (e.g., “large baskets”). Whether a basket size is “small” or “large” may be set by threshold values that are automatically determined, predefined and/or configurable. Each type of trip may be associated with the same types of items that are purchased. For example, quick trips may be associated with the same list of essential items that are purchased. As such, the type of trip may indicate locations in a given retail establishment that a consumer will visit.

Current trip instructions 126 may classify the current trip based on an identity of the consumer, an identity of the retail establishment, one or more items scanned, one or more locations visited, a day of the week, and/or other information. For example, current trip instructions 126 may determine one or more items that are scanned during the current shopping trip and determine that those items were previously scanned by the customer during a particular type of trip.

In some implementations, as items are scanned during the shopping trip, current trip instructions 126 may change or update the classification of the current trip. For example, current trip instructions 126 may keep a running total price and/or number of items that were scanned during the current shopping trip and change the classification accordingly. In this manner, as the classification of the current trip is changed, the system may change the models/correlations that are used to predict the next location of the consumer. In some implementations, current trip information collected by current trip instructions 126 (e.g., item scans, purchases, locations, time between scan times, etc.) may be stored in one or more databases described herein. Such current trip information may be used to further refine the models generated by location modeling instructions 122.

In some implementations, location predictor instructions 128 may program processor 122 to determine a prediction of one or more next locations that the consumer will visit during the current shopping trip based on a model that was generated by location modeling instructions 122. Location predictor instructions 128 may determine the model that should be used based on the segmentation of consumers performed by location modeling instructions 122, classification of the consumer of the current shopping trip by consumer profile instructions 124, current trip information from current trip instructions 126, and/or other information.

For example, location predictor instructions 128 may determine a level of similarity between the given consumer and one or more segments of consumers that were modeled by location modeling instructions 122. If location predictor instructions 128 determines that the characteristics of the consumer are the same or similar to the characteristics of a given segment of consumers, the model for that given segment may be used to predict the one or more next locations. For example, if the consumer (as determined based on the classification of the consumer) exhibited similar basket sizes, locations visited, consistency in previous shopping trips, and/or other previous behaviors or demographics as the given segment, the model for that given segment may be selected.

In some implementations, if the consumer does not share the same or similar characteristics as a given segment of consumers, then location predictor instructions 128 may determine whether the number of previous shopping trips known about the consumer exceeds a predefined and/or configurable threshold. If so, location prediction instructions 128 may use a model that specifically relates to the consumer. In other words, location prediction instructions 128 may predict the one or more next locations based on previous behaviors of the consumer if enough information is known about that consumer.

On the other hand, if not enough information is known about that consumer (e.g., the number of previous shopping trips known about the consumer does not exceed the predefined and/or configurable threshold), then location prediction instructions 128 may select a model that relates to the general population, a group of consumers who lives, shops, works, etc., at a similar geographic location as the consumer, and/or other population of consumers.

TABLE 1
Table 1 illustrates a matrix of variables and their respective values used
to segment consumers, profile a given consumer, and select
approriate prediction models based on similarities between the
segmented consumers that are modeled and the given consumer.

| Variable | Low | Medium | High |
|---|---|---|---|
| Number of trips | | x | |
| Consistency in | x | | |
| basket size | | | |
| Consistency in | | | x |
| direction | | | |
| Consistency in | x | | |
| locations visited | | | |
| Other variables | | | |

In Table 1 above, each consumer may be characterized based on one or more variables. The values “Low,” “Medium,” and “High” may be individually predefined and/or configurable. For example, a number of trips variable may be: “Low” when the number of recorded shopping trips for a given consumer is less than 10, “Medium” when the number is between 11 and 50 and “High” when the number is 51 and above. These values may be predefined and/or configurable by a user such as a retailer or others. The value for “Low” through “High” for other variables may be similarly predefined and/or configurable.

As illustrated in Table 1 above, a Medium number of recorded shopping trips is available for the consumer, the consumer exhibits low consistency in basket size (does not consistently have the same basket size), has a high degree of consistency in direction travelled, and low consistency of locations visited. This particular consumer may be compared with other consumers who share similar values. The matrix or similar information may be performed for each consumer in order to both group consumers with one another and to compare an individual consumer with other groups to identify appropriate models. The variables and matrix illustrated in Table 1 is exemplary only. Other variables and values may be used as well.

When the model has been selected, location prediction instructions 128 may predict the one or more next locations of the current shopping trip based on one or more known (previous or current) locations that the consumer has visited or is visiting during the current shopping trip and the model. For instance, location prediction instructions 128 may compare the one or more known locations with locations visited as described in the model. If locations similar to the one or more known locations are represented in the model, location prediction instructions 128 may determine the one or more next locations based on the model's prediction of the next location. The model's prediction is based on a sequence of locations that were visited by members of the population of one or more consumers that were modeled based on their previous shopping trips.

On the other hand, if the one or more known locations are not represented in the model, in some implementations, location prediction instructions 128 may extrapolate the next location based on various factors such as a time since shopping began. For example, if the current shopping trip has lasted five minutes, location prediction instructions 128 may determine, based on the selected model, where the modeled consumers typically were after five minutes and select that location as being the next likely location where the consumer will travel during the current shopping trip.

In some implementations, location prediction instructions 128 may change the selected model for location predictions. For instance, if information from current trip instructions 126 suggests that the incorrect model is being used, then location prediction instructions 128 may select a new model that may be more appropriate. In the foregoing the example, if the known locations of the current shopping trip are not represented in the current model, for instance, location prediction instructions 128 may select a new model that includes the known locations. In another example, because a given customer generally travels in a clockwise direction during shopping trips, the given customer may be segmented with shoppers who tend to travel in a clockwise direction during their respective shopping trips. Accordingly, to predict locations of the given customer during the current shopping trip, location prediction instructions 128 may initially use a model based on shoppers who travel in a clockwise direction. However, if the given customer is observed traveling in a counterclockwise direction during the current shopping trip, location prediction instructions 128 may change models during the current shopping trip such that a model that is based on shoppers who travelled in a counterclockwise direction is used for the current shopping trip instead.

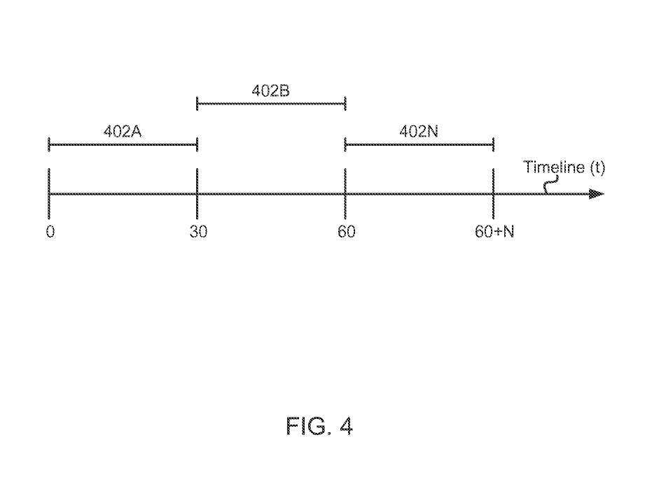

In some implementations, location prediction instructions 128 may make predictions of the one or more next locations at various times during the shopping trip. Furthermore, such predictions may relate to an interval of time such that the predictions “expire” after the interval of time has elapsed, as discussed below with respect to FIG. 4.

In some implementations, once a next location is predicted, location prediction instructions 128 may obtain information to be provided to the consumer based on the next location. The information to be provided may relate to an item that is nearby a path from the current location to the next location. Such information can include, for example, an incentive for the item, information that describes the item (e.g., nutrition information, price, etc.), recipes that can be used with the item (and items already scanned), and/or other information. In some implementations, location prediction instructions 128 may cause the information to be transmitted to the tracking device 150. Such transmission may include various communication protocols such as Short Message Service text message, Near-field communication, and/or other types of communication techniques, such as those described herein elsewhere.

In some implementations, location prediction instructions 128 may modify predictions of the one or more next locations based on information that is specific to the retail establishment at which the current shopping trip is taking place. The information that is specific to a retail establishment may include a particular layout of items sold at the retail establishment, inventory information, store/department hours, and/or other information that describes the retail establishment. In this manner, the system may customize results of the model based on the particular retail establishment at which the consumer is traversing.

For example, if a next location predicted for the consumer includes an item that is not currently sold by or is out of stock at a particular retail establishment where the consumer is shopping, the next location may be disregarded and the subsequent next location may be predicted based on the information that is specific to the retail establishment. In other instances, the model may determine where the consumer may go to potentially look for the item in question. For example, location modeling instructions 122 may determine an aisle where the item would be at the retail establishment and predict that the consumer will next travel to that location.

In some implementations, normalization instructions 130 may program processor 122 to normalize items and categories of items. For example, the configuration and layout of items are typically different across different retail establishments. Normalization instructions 130 may consult planogram or other information of the retail establishments so that a mapping of the item to a location at an individual retail establishment may be established. In this manner, the system may be applied across different retail establishments having different layouts of items. Location prediction instructions 128 may use the normalizations during processing so that predictions may be made irrespective of the particular retail establishment where a current shopping trip is taking place.

The system may be used to provide information that may be relevant to predicted locations. Furthermore, the system may be used to understand and correlate in-store traffic behavior for certain groups of consumers, in-store traffic behavior based on time of day, sales promotions, etc., and/or other consumer activity within a retail establishment. Other uses of the system will be apparent to those having skill in the art.

The various instructions described herein are exemplary only. Other configurations and numbers of instructions may be used, as well using non-modular approaches so long as the one or more physical processors are programmed to perform the functions described herein. It should be appreciated that although the various instructions are illustrated in FIG. 1 as being co-located within a single processing unit, in implementations in which processor(s) 122 includes multiple processing units, one or more instructions may be located remotely from the other instructions.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 120 may be programmed by one or more additional instructions that may perform some or all of the functionality attributed herein to one of the instructions.

The various instructions described herein may be stored in a storage device 140, which may comprise random access memory (RAM), read only memory (ROM), and/or other memory. The storage device may store the computer program instructions (e.g., the aforementioned instructions) to be executed by processor 122 as well as data that may be manipulated by processor 122. The storage device may comprise floppy disks, hard disks, optical disks, tapes, or other storage media for storing computer-executable instructions and/or data.

The various components illustrated in FIG. 1 may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1 and other drawing Figures, different numbers of entities than depicted may be used. Furthermore, according to various implementations, the components described herein may be implemented in hardware and/or software that configure hardware.

The various databases described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

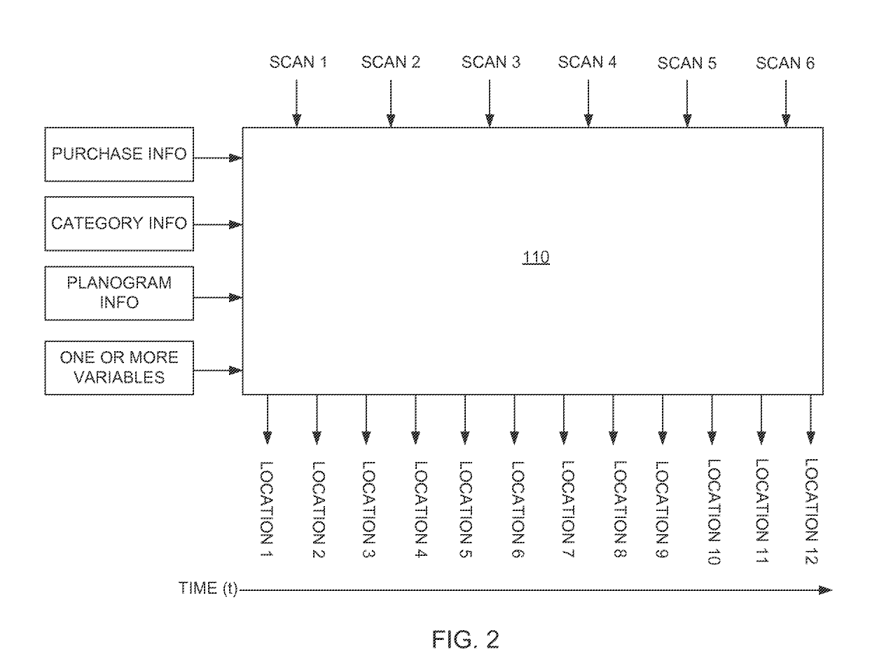

FIG. 2 illustrates a flow diagram of a system of predicting one or more next locations of a consumer within a retail establishment, according to an implementation of the invention. The various processing operations and/or data flows depicted in FIG. 2 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In some implementations, computer 110 may predict one or more next locations of a consumer that uses a self-scanning device during a current shopping trip at a retail establishment. Computer 110 may obtain purchase information, category information (e.g., to normalize items and categories), planogram or item location information of the retail establishment, one or more variables (e.g., as described above with respect to FIG. 1) related to the consumer, current shopping trip information that describes a current shopping trip, including current behavior of a consumer, and/or other information.

Based on the foregoing information, computer 110 may predict the one or more next locations periodically throughout the current shopping trip. For instance, at or after each scan (illustrated in FIG. 2 as Scans 1-6), one or more next locations (illustrated in FIG. 2 as Locations 1-12) may be predicted. In some implementations, the scans and/or other current trip information are stored and fed back into the model that is used to predict the one or more next locations. In this manner, the model may be refined and updated over time as information associated with new shopping trips is made available from the consumer and/or other consumers.

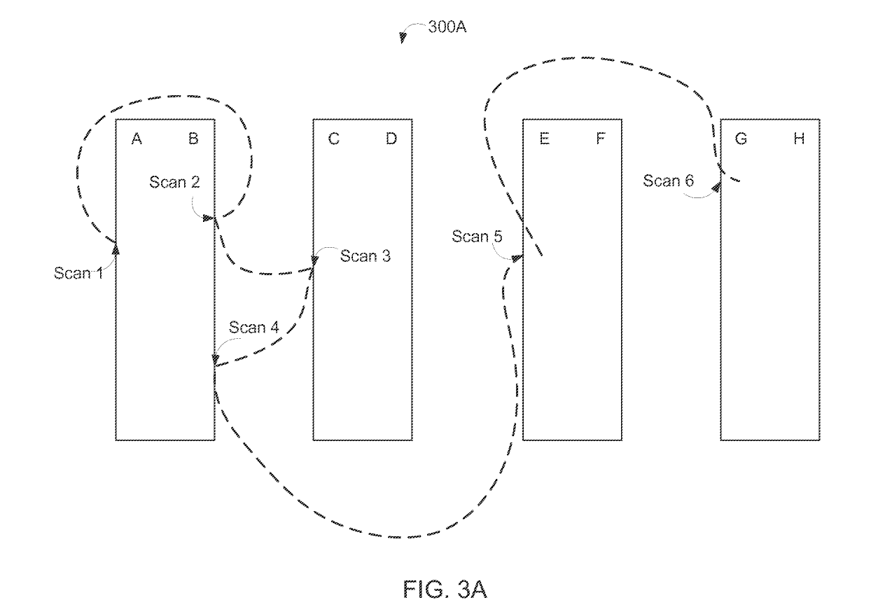

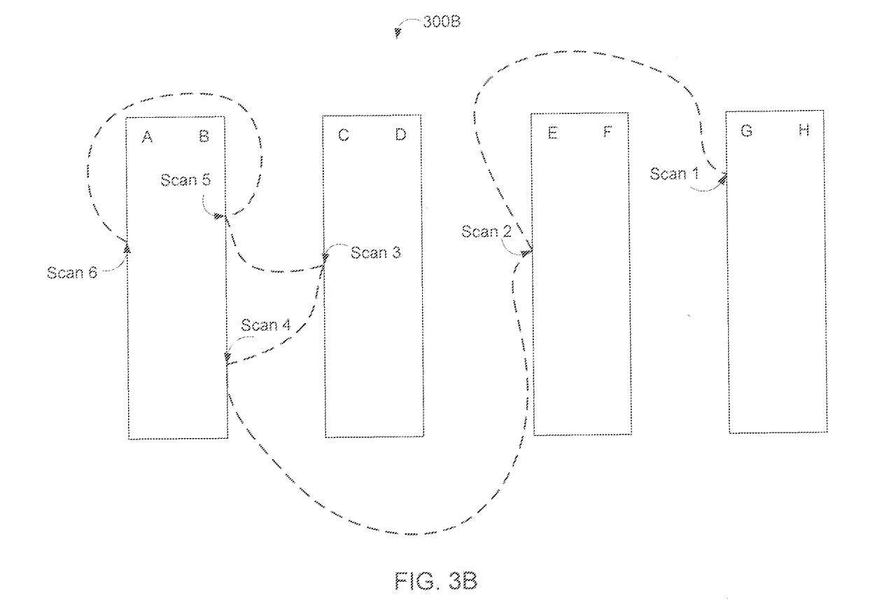

FIG. 3A schematically illustrates a first direction of travel within a retail establishment, according to an implementation of the invention. The directions of travel illustrated in FIGS. 3A and 3B may be determined using some or all of the system components described in detail above. FIG. 3A illustrates a path (illustrated in dotted line) of a consumer during a shopping trip. As illustrated in FIG. 3A, the consumer makes various scans (Scans 1-6) of items at various aisles (A-H), which indicate locations visited during the shopping trip. In FIG. 3A, individual paths from Scan 1 to Scan 2, Scan 2 to Scan 3, and Scan 5 to Scan 6 were in a first “direction.” Scan 3 to Scan 4 and Scan 4 to 5 was in a second direction opposite the first direction.

The system may assume that during the illustrated shopping trip, the consumer travelled in a generally first direction (e.g., clockwise) because a ratio of the number of first direction paths (three) and the number of second direction paths (two) exceed a predefined and/or configurable threshold. As such, the shopping trip illustrated in FIG. 3A may be categorized as one that was traversed in a first direction in the retail establishment. As described with respect to FIG. 1, direction of travel during a shopping trip may be used as an indicator to predict next locations. For example, if a given model predicts that a next location could include one of two locations, the model may select the location that is in the direction of the predicted direction of travel.

FIG. 3B schematically illustrates a second direction of travel within a retail establishment, according to an implementation of the invention. FIG. 3B illustrates various scans and aisles as in FIG. 3A but in an overall different direction. As illustrated, for example, Scan 1 to Scan 2, Scan 3 to 4, and Scan 5 to 6 are in a first direction, while Scan 2 to 3 and Scan 4 to 5 are in a second direction opposite the first direction. As such, the shopping trip illustrated in FIG. 3B may be categorized as one that was traversed in a second direction (opposite the first direction illustrated in FIG. 3A) in the retail establishment. Referring to FIGS. 3A and 3B, the directionality of travel between two scans may be based on a reference point such as a particular aisle or other reference point.

FIG. 4 schematically illustrates predictions of one or more next locations 402 (illustrated in FIG. 4 as location 402A, 402B, . . . , 402N) made at various intervals along a timeline, according to an implementation of the invention. A timeline (t) is illustrated with various time points (0, 30, 60, 60+N). At time point 0 (which can be measured in seconds, or minutes, etc., although “seconds” will be used with respect to FIG. 4 as an example), a scan or other location indicia may be received indicating that the consumer is or was at a particular location at time point 0 seconds (e.g., at the first scan or other location identifying event). A prediction of one or more next locations may be made based on the particular location and/or other information as described herein. The one or more next locations may be associated with a time interval such that the consumer is expected to travel to the one or more next locations during the time interval.

The time interval may be based on previous times between scans (indicating how long the particular consumer and/or group of consumers have taken during previous shopping trips to travel to the next location), distance between locations (e.g., a given establishment at which the current shopping trip is occurring may be bigger or smaller than previous retail establishments, lengthening or shortening the predicted time). For example, a next location 402A may be predicted between the time interval 0 to 30 seconds. If the time interval 0 to 30 seconds passes and the next location was not traversed to, the system may generate a new predicted next location 402B (or may simply maintain the current predicted next location) for the time interval 30 to 60 seconds. The process may continue until the end of the current trip (e.g., a next location 402N, etc., may be predicted). The system may provide information that may be relevant to the predicted location (e.g., coupons, recipes, etc.). For example, information relevant to next location 402A may be provided to the consumer after time 0 seconds and at or before time 30 seconds (e.g., during the 0 to 30 second time interval). In some implementations, next locations 402A-402N may be determined at the same time or serially after respective time periods have expired. In some implementations, the system may determine whether or not the predictions were accurate and store such metrics so that future predictions may be fine-tuned.

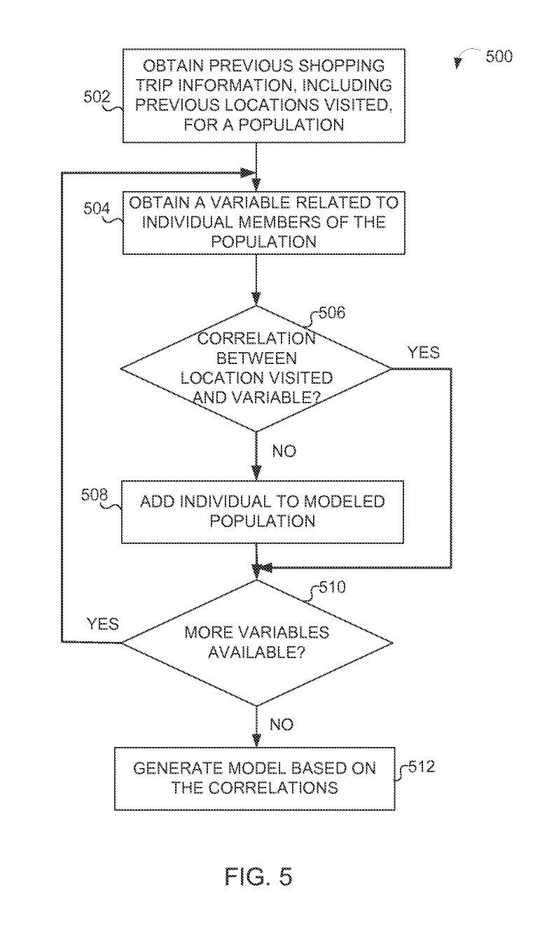

FIG. 5 illustrates a process 500 of generating a model of locations visited and one or more variables related to a population of consumers that have previously shopped within a retail establishment, according to an implementation of the invention. The generated model may be used to predict locations to which a consumer will likely traverse during a current shopping trip by comparing characteristics (e.g., values of one or more variables) of the consumer with characteristics of the population of consumers that were modeled. If consumer characteristics match (e.g., are the same or similar within a predefined and/or configurable threshold for individual and/or cumulative characteristics) the population's characteristics, the model may infer that the consumer will likely visit the same or similar locations that the general population visited as well.

In an operation 502, previous shopping trip information may be processed. For example, previous shopping trip information may be retrieved from a database of previous shopping trips that are available to the system. Such information may have originally been obtained from participating retail establishments that provide shopping trip information to the system. From the previous shopping trip information, which may include information related to a population of all consumers for which the system has information, the locations visited during the previous shopping trips by the population may be obtained based on the processing.

In an operation 504, a variable related to individual consumers of the population may be obtained. The variable may relate to an item scanned, an item purchased, a time between scans, a basket size, other information related to the previous shopping trip, demographic information of an individual consumer, and/or other information.

In an operation 506, a determination of whether the variable is correlated with any one or more of the locations may be made. For example, a basket size of five items may be tightly correlated with an essential item such as milk (e.g., a location associated with milk). In other words, a certain percentage of basket sizes of five items that were observed in the population of consumers may be associated with milk, and that percentage may exceed a threshold criterion that causes the value of “5” for the variable “basket size” to be correlated with milk. Such a correlation may allow a model to predict that a consumer who frequently makes shopping trips of similarly small basket sizes will likely travel to a location where milk is sold within a given retail establishment. In another example, a trip length of greater than 30 minutes may be correlated with at least one purchase in a produce section. The foregoing example may allow a model to predict that a consumer who is shopping above a threshold length of time will visit the produce section. Other types of correlations with locations may be made as well.

If the variable is correlated with a visited location, consumers whose value for the variable is the same as or similar to the correlated value may be added to the population of consumers being modeled in an operation 508.

In an operation 510, a determination of whether more variables are available to process may be made. If more variables are available, processing may return to operation 504. If no more variables are available, the population of consumers may be modeled based on the variable and location correlations in an operation 512.

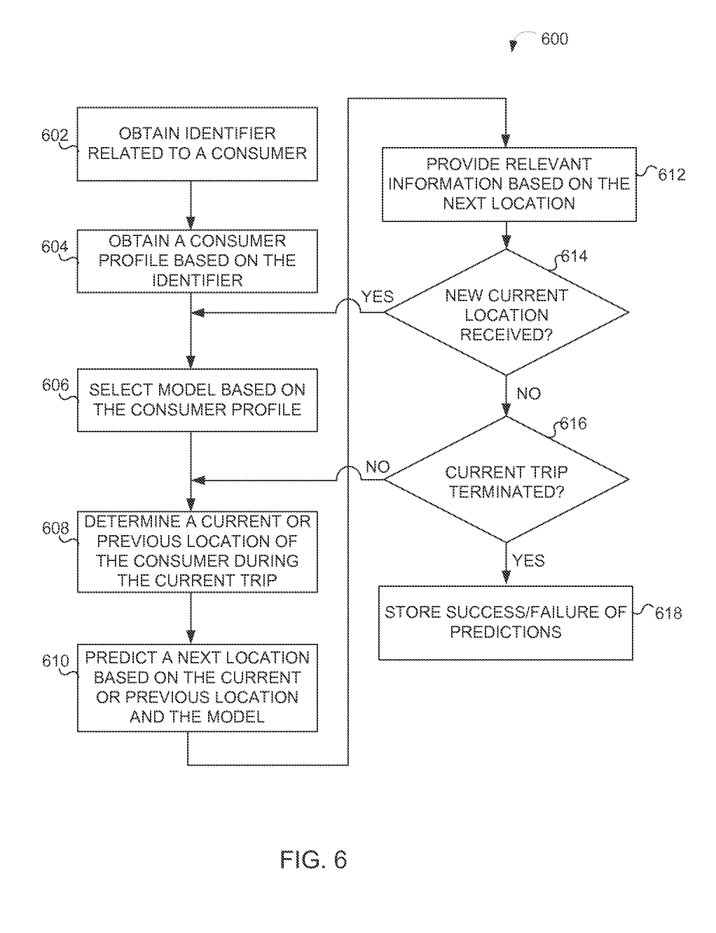

FIG. 6 illustrates a process 600 of predicting one or more next locations of a consumer within a retail establishment, according to an implementation of the invention.

In an operation 602, an identifier related to a consumer may be obtained. The identifier may include a loyalty card identifier that was scanned by the user, a mobile device identifier that identifies a mobile device of the consumer that is being used in self-scan system, and/or other identifier that can be used to identify the consumer. For example, a consumer may enter a retail establishment and pick up a self-scanner device provided by the retail establishment and scan the consumer's loyalty card or other identification medium. In another example, the user may activate a self-scan mobile application, which may transmit a mobile device identifier and/or may be used to scan the customer's loyalty card. Other examples can occur as well, such as the user picking up or activating a device used to directly track the location of the user.

In an operation 604, a consumer profile may be obtained. For example, the consumer profile may be pre-stored in association with the identifier. The consumer profile may include previous shopping behavior of the consumer, demographic information of the consumer, and/or other information that may be used to classify the consumer as being similar to one or more groups of consumers (or not being similar to any particular group).

In an operation 606, a model that is used to predict one or more next locations for the consumer may be selected based on the consumer profile. For example, characteristics from the consumer profile may be compared with characteristics of members of the population of consumers that were modeled to select an appropriate model for the consumer.

In an operation 608, a current and/or previous location of the consumer within the retail establishment during the current shopping trip may be determined. The determination may be made based on a scanned item whose location is known, location information from location techniques described herein, and/or other method.

In an operation 610, the one or more next locations may be determined based on the selected model, the current location, elapsed time since the current shopping trip began, elapsed time since the last location indication (e.g., last scan), and/or other information.

In an operation 612, information that is relevant to the one or more next locations may be provided to the customer (e.g., via the customer's mobile device and/or other device that is accessible to the consumer during the current shopping trip). The information may include an incentive for an item that is located along a path to the next location, a recipe involving the item, nutrition information, apparel sizing/material information, and/or other information.

In an operation 614, a determination of whether a new location is received may be made. If a new location of the consumer is received, processing may return to operation 608. If a new location is not received, a determination of whether the current shopping trip is terminated may be made in an operation 616. The current shopping trip may be indicated as being terminated by an indication that a checkout/payment process has been initiated, the consumer has exited the retail establishment, and/or other termination indication

In operation 616, if the current shopping trip is terminated, the predictions and success or failure of the predictions may be stored for refining the model in an operation 618. If the current shopping trip is not terminated, processing may return to operation 610.

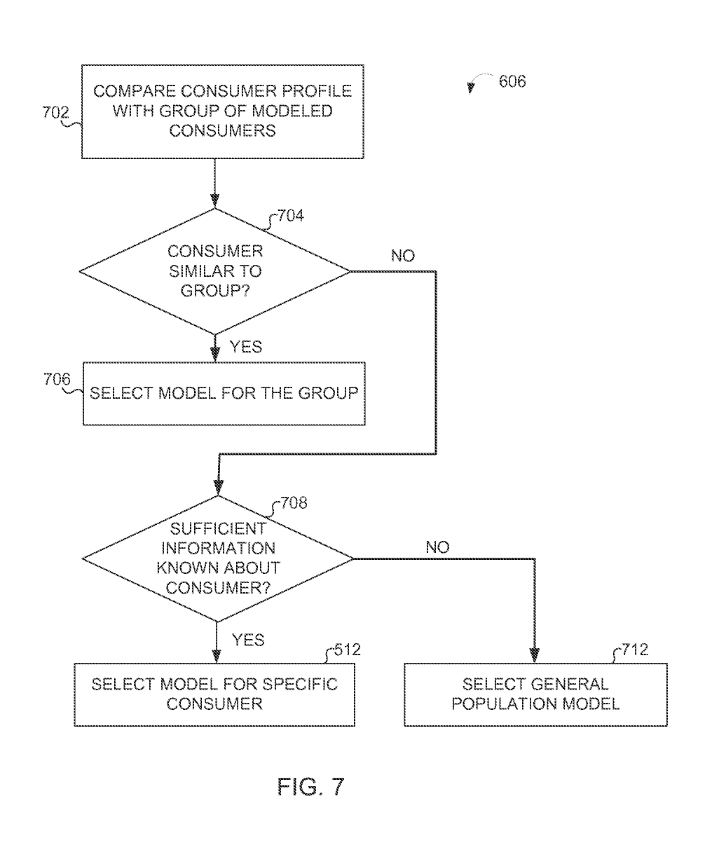

FIG. 7 illustrates a process 606 of determining a model used to predict one or more next locations of a consumer within a retail establishment, according to an implementation of the invention.

In an operation 702, the consumer profile may be compared to characteristics of a group of consumers that have been modeled. In an operation 704, a determination of whether one or more characteristics of the consumer (as described in the consumer profile) are similar to the characteristics of the group of consumers may be made.

In an operation 706, if the consumer's characteristics are the same as or similar to the characteristics of the group of consumers, then the model for that group of consumers may be selected. If the consumer's characteristics are the same as or similar to multiple groups of consumers, the multiple groups of consumers may be ranked with respect to each other to determine which group has the highest similarity to the consumer. Such similarity may be judged based on levels of differences between values of the one or more variables that are correlated to visited locations, as described with respect to FIG. 1.

In an operation 708, if the consumer's characteristics are not the same as or similar to the characteristics of any of the group of consumers, then a determination of whether sufficient information is known about the consumer's previous history (e.g., whether a number of the consumer's previous shopping trips that have been stored exceeds a predefined and/or configurable threshold) may be made. If sufficient information is known about the consumer, then a model based on the consumer's previous shopping behavior may be selected in an operation 710. If sufficient information is not known about the consumer, then a model for the general population may be selected in an operation 712.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer-implemented method of determining predictions of one or more locations to which a consumer will travel within a retail establishment, the method being implemented by a computer having one or more physical processors programmed with computer program instructions that, when executed, perform the method, the method comprising:
obtaining by the computer, an identifier related to the consumer during a current shopping trip that is occurring within the retail establishment;
obtaining, by the computer, at least a first characteristic of the consumer based on the identifier;
identifying, by the computer, at least one location within the retail establishment to which the consumer has travelled during the current shopping trip;
obtaining, by the computer, at least a first correlation between the first characteristic and a plurality of locations, wherein the first correlation is based on information that indicates a population of consumers associated with the first characteristic individually visited the plurality of locations;
determining, by the computer, that the at least one location to which the consumer has travelled during the current shopping trip is among the plurality of locations individually visited by the population of consumers;
predicting, by the computer, that the consumer will likely travel to one or more of the plurality of locations based on the first correlation and the determination that the at least one location is among the plurality of locations;
determining, by the computer, relevant information based on the one or more locations; and
causing, by the computer, the relevant information to be provided to the consumer.

2. The method of claim 1, the method further comprising:
obtaining, by the computer, the first characteristic for at least a first consumer different from the consumer;
obtaining, by the computer, a first location within the retail establishment visited by the first consumer during the previous shopping trip;
correlating, by the computer, the first location and the first characteristic to generate the first correlation; and
causing, by the computer, the first correlation to be stored such that the first correlation is selectable.

3. The method of claim 1, wherein the method further comprising:
obtaining, by the computer, a series of previous locations within the retail establishment visited by the consumer during a previous shopping trip of the consumer; and
determining, by the computer, a direction of travel that the consumer has used during the previous shopping trip based on the series of previous locations, wherein the first characteristic comprises the direction of travel.

4. The method of claim 1, wherein the method further comprising:
obtaining, by the computer, information related to a plurality of items that were scanned during a previous shopping trip of the consumer; and
determining, by the computer, a basket size based on the plurality of items, wherein the first characteristic comprises the basket size.

5. The method of claim 1, wherein the method further comprising:
obtaining, by the computer, a first shopping behavior of the consumer made during a first previous shopping trip;
obtaining, by the computer, a second shopping behavior of the consumer made during a second previous shopping trip;
determining, by the computer, a level of consistency between the first shopping behavior and the second shopping behavior, wherein the first characteristic comprises the level of consistency.

6. The method of claim 5, wherein the first shopping behavior comprises a first direction of travel that the consumer made during the first previous shopping trip and the second shopping behavior comprises a second direction of travel that the consumer made during the second previous shopping trip, and
wherein determining the level of consistency comprises determining whether the first direction is the same as the second direction.

7. The method of claim 5, wherein the first shopping behavior comprises a first basket size resulting from the first previous shopping trip and the second shopping behavior comprises a second basket size resulting from the second previous shopping trip, and
wherein determining the level of consistency comprises determining whether the first basket size is similar to the second basket size within a threshold value.

8. The method of claim 5, wherein the first shopping behavior comprises a first location visited during the first previous shopping trip and the second shopping behavior comprises a second location visited during the second previous shopping trip, and
wherein determining the level of consistency comprises determining whether the first location is the same as the second location.

9. The method of claim 1, wherein the method further comprising:
segmenting, by the computer, a plurality of consumers into at least a first group based on the first characteristic shared by individual ones of the plurality of consumers, wherein the first correlation between the first characteristic and the plurality of locations is based on the first group having visited the plurality of locations, and
wherein obtaining the first correlation comprises determining that the consumer shares the first correlation in common with the first group.

10. The method of claim 1, wherein obtaining the at least one location comprises:
obtaining, by the computer, an indication of an item that was scanned during the current shopping trip;
determining, by the computer, a location at which the item is sold at the retail establishment, wherein the at least one location comprises the location at which the item is sold.

11. The method of claim 1, wherein the method further comprising:
identifying, by the computer, a new location of the consumer;
determining, by the computer, a second correlation between a second characteristic and a second plurality of locations, wherein the second plurality of locations comprises the new location; and
replacing, by the computer, the first correlation with the second correlation.

12. The method of claim 1, wherein predicting that the consumer will likely travel to the one or more locations comprises:
predicting that the consumer will likely travel to a first location during a first time interval; and
predicting that the consumer will likely travel to a second location during a second time interval.

13. The method of claim 12, wherein the first interval and the second interval are determined based on a previous time between scans during a previous shopping trip of the consumer.

14. The method of claim 12, wherein the first interval is determined based on a distance between the first location and the at least one location.

15. A system of determining predictions of one or more locations to which a consumer will travel within a retail establishment, the system comprising:
a computer having one or more physical processors programmed with computer program instructions to:
obtain an identifier related to the consumer during a current shopping trip that is occurring within the retail establishment;
obtain at least a first characteristic of the consumer based on the identifier;
identify at least one location within the retail establishment to which the consumer has travelled during the current shopping trip;
obtain at least a first correlation between the first characteristic and a plurality of locations, wherein the first correlation is based on information that indicates a population of consumers associated with the first characteristic individually visited the plurality of locations;
determine that the at least one location to which the consumer has travelled during the current shopping trip is among the plurality of locations individually visited by the population of consumers;
predict that the consumer will likely travel to one or more of the plurality of locations based on the first correlation and the determination that the at least one location is among the plurality of locations;
determine relevant information based on the one or more locations; and
cause the relevant information to be provided to the consumer.

16. The system of claim 15, wherein the computer is further programmed to:
obtain the first characteristic for at least a first consumer different from the consumer;
obtain a first location within the retail establishment visited by the first consumer during the previous shopping trip;
correlate the first location and the first characteristic to generate the first correlation; and
cause the first correlation to be stored such that the first correlation is selectable.

17. The system of claim 15, wherein the computer is further programmed to:
obtain a series of previous locations within the retail establishment visited by the consumer during a previous shopping trip of the consumer; and
determine a direction of travel that the consumer has used during the previous shopping trip based on the series of previous locations, wherein the first characteristic comprises the direction of travel.

18. The system of claim 15, wherein the computer is further programmed to:
obtain information related to a plurality of items that were scanned during a previous shopping trip of the consumer; and
determine a basket size based on the plurality of items, wherein first characteristic comprises the basket size.

19. The system of claim 15, wherein the computer is further programmed to:
obtain a first shopping behavior of the consumer made during a first previous shopping trip;
obtain a second shopping behavior of the consumer made during a second previous shopping trip;
determine a level of consistency between the first shopping behavior and the second shopping behavior, wherein the first characteristic comprises the level of consistency.

20. The system of claim 19, wherein the first shopping behavior comprises a first direction of travel that the consumer made during the first previous shopping trip and the second shopping behavior comprises a second direction of travel that the consumer made during the second previous shopping trip, and
wherein the level of consistency is determined based on whether the first direction is the same as the second direction.

21. The system of claim 19, wherein the first shopping behavior comprises a first basket size resulting from the first previous shopping trip and the second shopping behavior comprises a second basket size resulting from the second previous shopping trip, and
wherein the level of consistency is determined based on whether the first basket size is similar to the second basket size within a threshold value.

22. The system of claim 19, wherein the first shopping behavior comprises a first location visited during the first previous shopping trip and the second shopping behavior comprises a second location visited during the second previous shopping trip, and
wherein the level of consistency is determined based on whether the first location is the same as the second location.

23. The system of claim 15, wherein the computer is further programmed to:
segment a plurality of consumers into at least a first group based on the first characteristic shared by individual ones of the plurality of consumers, wherein the first correlation between the first characteristic and the plurality of locations is based on the first group having visited the plurality of locations, and
wherein the first correlation is obtained based on a determination that the consumer shares the first correlation in common with the first group.

24. The system of claim 15, wherein the computer is further programmed to:
obtain an indication of an item that was scanned during the current shopping trip;
determine a location at which the item is sold at the retail establishment, wherein the at least one location comprises the location at which the item is sold.

25. The system of claim 15, wherein the computer is further programmed to:
identify a new location of the consumer;
determine a second correlation between a second characteristic and a second plurality of locations, wherein the second plurality of locations comprises the new location; and
replace the first correlation with the second correlation.

26. The system of claim 15, wherein the plurality of locations comprises a first location and a second location, and wherein processor is further programmed to:
predict that the consumer will likely travel to the first location during a first time Interval; and
predict that the consumer will likely travel to the second location during a second time interval.

27. The system of claim 26, wherein the first interval and the second Interval are determined based on a previous time between scans during a previous shopping trip of the consumer.

28. The system of claim 26, wherein the first interval is determined based on a distance between the first location and the at least one location.
